(19) United States
(12) Patent Application Publication
(10) Pub. No.: US 2016/0257422 A1
(43) Pub. Date: Sep. 8, 2016

(54) DEVICE FOR AEROPLANE LANDING MONITORING

(71) Applicant: AMBITON SP. Z O.O., Rzeszów (PL)

(72) Inventor: MARCIN CEBULAK, LANCUT (PL)

(73) Assignee: AMBITON Sp. z o.o., RZESZÓW (PL)

(21) Appl. No.: 14/433,867

(22) PCT Filed: Mar. 31, 2014
(86) PCT No.: PCT/PL2014/000033

§ 371 Date: Apr. 7, 2015

(30) Foreign Application Priority Data
Mar. 27, 2014 (PL) P.407686

(51) Int. Cl. B64D 45/04; G08G 5/00

(52) U.S. Cl. CPC B64D 45/04; G08G 5/0086

(57) ABSTRACT

A device for aeroplane landing monitoring equipped with a microprocessor system for measuring height of an aeroplane above airfield apron in order to ensure correct course of landing and avoid damage of undercarriage or even the structure of fuselage and wings characterised in that the device (2) located in aeroplane (1) is equipped with a system of multi-channel measurement microprocessor sensors comprising a system of nose sensors (3) in the front part of the aeroplane and the system of tail sensors (4) in the rear part of the aeroplane. Each of the multi-channel measurement microprocessor sensor systems (3, 4) comprises at least one measurement sensor.

The subject of the invention is a device for monitoring the process of landing of aeroplanes, especially passenger liners, the objective of which is to ensure correct course of landing and avoid damage of undercarriage or even destruction of structure of fuselage and wings.

The correct course of landing is important not only on account of security of pilots and passengers but also for reasons concerning structure of the aeroplane—incorrectly performed landing manoeuvre may result in a damage to the undercarriage or even destruction of fuselage structure and wings.

According to Polish patent description P.312931, in case of occurrence of a failure in an aeroplane potentially hazardous to safety of crew and passengers in the course of landing, aeroplanes with single- and multi-flow jet engines should be provided with the option to discontinue the flight and land, also vertically, in any terrain thanks to the possibility to move horizontally in air in order to choose a terrain suitable for landing and to land the aeroplane on the ground. To accomplish this, single-flow and multi-flow jet engines should be provided with separately led-out additional drives that, via appropriate couplings, would transfer propulsion onto fans located in separate flow pipes. From fan ducts of multi-flow fan engines and separate flow pipes located in airframes, wings and stabilisers of aeroplanes, air would find its way to sliding slots. From slits in the slots distributed along the direction of span of wings and horizontal and/or vertical stabilisers, a forced airflow is realised, in case of wings and horizontal stabilisers only over their upper surface, and in case of rudder symmetrically on both surfaces which ensures appropriate value of the aerodynamic lift. Vertical take-off or aeroplane start with shortened take-off run is also possible provided that appropriate flow intensity of airflow forced to wings and stabilisers is ensured.

Known from description of application P.380094 is the method consisting in that the height of the front undercarriage leg is adjusted and long which makes possible that an aeroplane lands on all wheels at large angles of approach.

Also from description of application P.398230 known is a system of optical observation of aeroplanes coming down for landing that comprises a camera located in front of beginning point of the runway and on its axis with its lens pointed in direction opposite to the runway direction in such a manner that the optical axis of the camera coincides with the runway axis in the azimuth while in the elevation, the angle between the camera's optical axis and the runway plane is from 2.5 degrees to 5 degrees, and another camera is positioned on one side of the runway, at the distance from the beginning of the runway corresponding to the touch-down point, with its lens directed toward the beginning of the runway, while in elevation the angle between the camera's optical axis and the runway plane is from 2.5 degrees to 3.5 degrees, and in the azimuth the camera's optical axis crosses the runway axis at a distance larger than 1000 metres. Video signals from the cameras are transmitted by means of transmitting-receiving devices to other transmitting-receiving devices and further to a computer-based video processing device, and the signals acquired from cameras are displayed on monitors. The system comprises also a control pulpit for controlling the optics of the cameras. The cameras operate either in the visible light or in the infrared radiation wavelength band.

The objective of the present invention is a device that will allow to determine the right moment for making the rate of descent “shallower” and levelling out an aeroplane in order to obtain the maximum possible parallelism of the velocity vector to the runway surface. Correct determination of the height at which such manoeuvre is performed is a precondition for safe and comfortable touchdown. In conditions characterised with limited visibility, correct determination of height above the airfield apron can be uncertain or even impossible.

The essential idea of the invention consists in the use of a device equipped with a microprocessor system for measuring the height of the aeroplane over the airfield apron within a small range (up to several metres) but with a high accuracy and a system signalling to the pilot that a height optimal for carrying out the touch-down manoeuvre has been attained. The use of a multi-channel height measurement system employing a wide spectrum of electromagnetic waves ensures immunity to interference and measurement resolution in a given measurement range adequate for the application at issue.

One of the merits of the device consists in correct determining of height in the course of the manoeuvre of approaching to landing that facilitates safe and comfortable touch-down thanks to the use of the device equipped with sensors measuring the flight parameters.

The subject of the invention is illustrated by means of an example embodiment shown in schematic drawings, of which

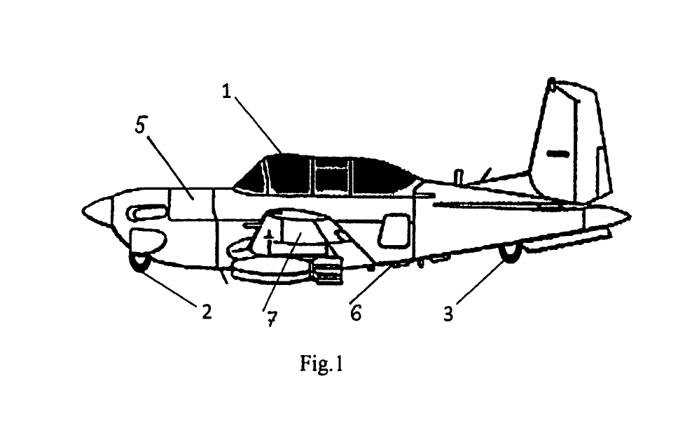

FIG. 1 presents an aeroplane in the position corresponding to a horizontal flight, and

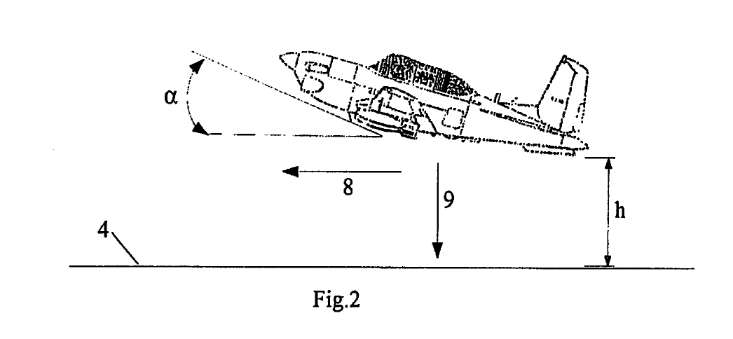

FIG. 2 shows the aeroplane in the position corresponding to the angle of approach α.

An aeroplane 1 is equipped with a device 5 comprising a system of nose sensors 2 and a system of tail sensors 3. The key flight parameters measured by the sensors include: height h over the airfield apron surface, angle α between the fuselage axis and the apron surface or the angle of approach, the aeroplane linear velocity with respect to the airfield apron—the velocity in horizontal direction denoted 8 in the figure, vertical velocity denoted 9 in the figure, as well as the angle 7 between wings and the apron plane (the angle of roll). At its output, the device 5 is equipped with an indicator in the form of a control light and/or an acoustic signal. Device 5 automatically generates a light and/or sound signal at the moment of finding conditions optimal for landing the aircraft undercarriage 6 on the airfield apron 4.

The measurement is carried out with a redundancy by means of at least two independent methods to assure that reliable results will be obtained in all weather conditions and over any possible surface.

The device according to the invention constitutes an aid for the pilot in making his decisions in the form of a microprocessor-based system to which sensors measuring flight parameters are connected.

1. A device for aeroplane landing monitoring equipped with a microprocessor system used to measure the height of the aeroplane over an airfield apron in order to ensure correct course of landing characterised in that the device (5) located in the aeroplane (1) is equipped with a multi-channel measurement microprocessor sensor system comprising a nose sensor system (2) in the front part of the aeroplane and the tail sensor system (3) on the rear part of the aeroplane.

2. The device according to claim 1 characterised in that each of the multi-channel measurement microprocessor sensor systems (2, 3) comprises at least one measuring sensor.

3. The device according to claim 1 characterised in that the multi-channel measurement microprocessor sensor systems (2, 3) employ electromagnetic waves with wide frequency spectrum.
